(19) United States
(12) Patent Application Publication
(10) Pub. No.: US 2002/0198947 A1
(43) Pub. Date: Dec. 26, 2002

(54) Electronic document sender system and method with external address access

(76) Inventor: Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/887,833

(22) Filed: Jun. 21, 2001

(51) Int. Cl. G06F 15/16

(52) U.S. Cl. 709/206

(57) ABSTRACT

A method of electronic document sending comprises importing an electronic address of an electronic document receiver from a mobile computing device into an electronic document sender and sending an electronic document from the electronic document sender to the electronic address. An electronic document sender comprises a communication module configured for electronically sending an electronic document to an electronic address of an electronic document receiver and configured for importing the electronic address of the electronic document receiver from a mobile computing device.

### FIELD OF THE INVENTION

The present invention relates to electronic document transmission and in particular, to accessing electronic addresses for electronic document transmission.

### BACKGROUND OF THE INVENTION

With the use of a document scanner or digital sender, almost anyone can conveniently transform a paper document into an electronic one. Once the electronic image is formed, the electronic document can be stored, printed back into a paper document (e.g. copied), or be sent electronically via email or facsimile to a desired recipient. The recipient is identified by an electronic address such as electronic mail address, facsimile number, host address, uniform resource locator address, as well as other types of telecommunication and network addresses. These electronic addresses can be entered into the scanner or digital sender each time that a document is sent and/or stored in an electronic address book of the scanner or digital sender for future use.

Although the end result of sending documents electronically with these devices is convenient, sometimes preparing to send the documents is awkward. For example, many scanners have input devices such as limited alpha-numeric keypads that make entering target electronic address(es) cumbersome. This problem is particularly vexing and time-consuming for anyone desiring to enter multiple electronic addresses, such as in a distribution list. Moreover, since many scanners or digital senders in a business environment are used by many different people, it may not be desirable from a privacy perspective to enter a user's target address(es) into the memory of the scanner/sender. While nearby desktop computers might be available to assist in entering address information to the scanner/sender, this arrangement may also compromise the privacy of the user's electronic addresses and is equally time-consuming.

Accordingly, high volume use of conventional scanners and digital senders is hampered, particularly when a user desires to send an electronic document to multiple electronic addresses on a distribution list.

### SUMMARY OF THE INVENTION

A method of electronic document sending of the present invention comprises importing an electronic address of at least one electronic document receiver from a mobile computing device into an electronic document sender and sending an electronic document from the electronic document sender to the electronic address.

An electronic document sender of the present invention comprises a communication module configured for electronically sending an electronic document to an electronic address of an electronic document receiver and configured for importing the electronic address of the electronic document receiver from a mobile computing device.

### BRIEF DESCRIPTION OF THE DRAWINGS

FIG. 1 is a block diagram of an electronic document sending system, according to one embodiment of the present invention.

FIG. 2 is a flow diagram of an electronic document sending method, according to one embodiment of the present invention.

FIG. 3 is a schematic illustration of an electronic document sending system, according to one embodiment of the present invention.

FIG. 4 is a block diagram of a user interface of an electronic document sending system, according to one embodiment of the present invention.

FIG. 5 is a block diagram of a menu of the user interface of FIG. 4, according to one embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

A method and system of electronic document sending of the present invention comprises importing an electronic address of an electronic document receiver from a mobile computing device into an electronic document sender and sending an electronic document from the electronic document sender to the electronic address. This method and system permits a user to walkup to an electronic document sender and immediately send a document to one or multiple electronic addresses without manually entering the addresses into the electronic document sender.

Components of the present invention may be implemented in hardware via a microprocessor, programmable logic, or state machine, in firmware, or in software within a given device. In one aspect, at least a portion of the software programming is web-based and written in HTML and JAVA programming languages, including links to graphical user interfaces, such as a windows-based operating system. The components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may reside in software on one or more computer-readable mediums. The term computer-readable mediums as used herein is defined to include any kind of memory, volatile or non-volatile, such as floppy disks, hard disks, CD-ROMs, flash memory, read-only memory (ROM), and random access memory (RAM).

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows.” Each window has its own adjustable boundaries which allow the user to enlarge or shrink the application or document relative to the display screen. Each window can act independently, including its own menu, toolbar, pointers, and other controls, as if it were a virtual display device. Other software tools may be employed via the window, such as a spreadsheet for collecting data. The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

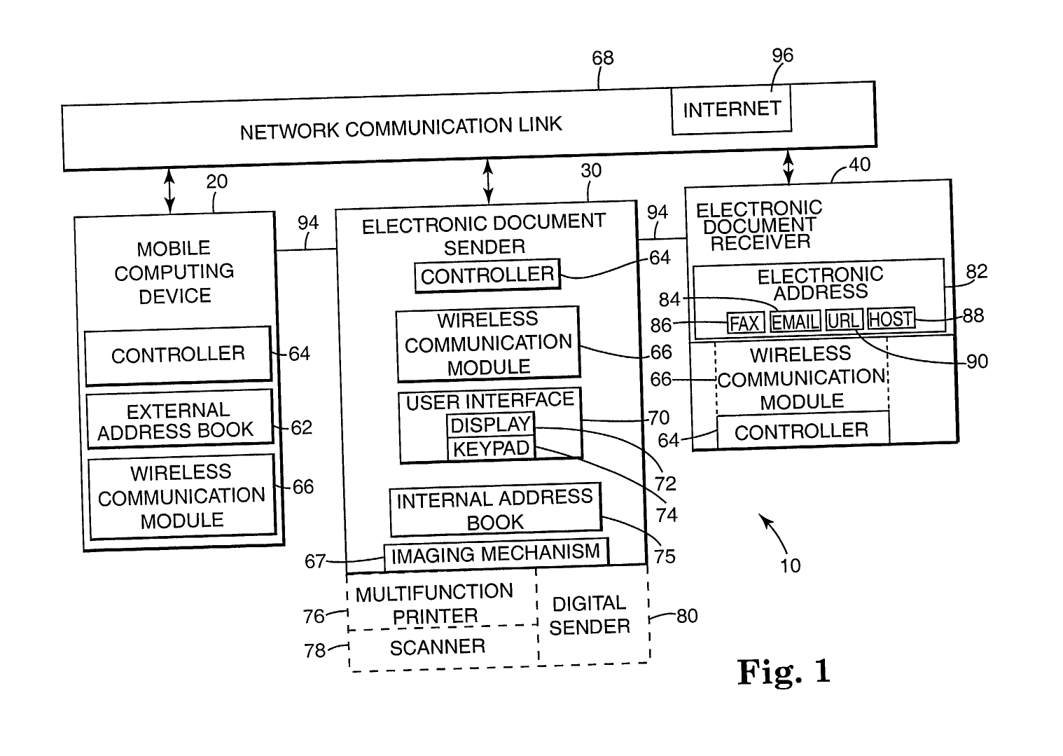

An electronic document sending system according to the present invention is illustrated generally at 10 in FIG. 1. System 10 includes mobile computing device 20, electronic document sender 30, and electronic document receiver 40. Mobile computing device 20 and electronic document sender 30 each include controller 64 and wireless communication module 66, while electronic document receiver 40 includes controller 64 and only optionally includes wireless communication module 66. Mobile computing device 20 also includes external address book 62, while system 10 further includes network communication link 68.

Electronic document sender 30 further includes imaging mechanism 67, user interface 70 having display 72 and keypad 74, and internal address book 75. Electronic document sender 30 further optionally forms a portion of multifunction printer 76, scanner 78, or digital sender 80. Multifunction printer 76 includes the ability to copy documents as well as send electronic documents by facsimile or electronic mail.

Mobile computing device 20 is preferably configured as a handheld or notebook computer, personal digital assistant, or mobile phone, each being configured for wireless communication via wireless communication module 66. External address book 62 of mobile computing device 20 stores names, street addresses, phone numbers and electronic addresses of electronic communication devices and electronic computing devices with which the user may communicate.

Electronic document sender 30 includes imaging mechanism 67 for transforming an image of a paper document into an electronic form, such as an electronic document, that can be stored digitally and/or electronically transported to a recipient (e.g., email, facsimile, or diskette). A paper document includes any physical object capable of being imaged, including but not limited to a transparency, plastic, as well as a metal or wood carving and other objects. Electronic document sender 30 may include any one of flatbed scanners, document feed scanners, handheld scanners, digital cameras as well as multi function machines incorporating a scanning module, and digital senders. Electronic document sender 30 is programmable to permit selective functioning with, and wired and/or wireless communication with, mobile computing device 20 and electronic document receiver 40. Internal address book 75 of electronic document sender 30 holds names, street addresses, phone numbers and electronic addresses of electronic communication devices and electronic computing devices with which the user may communicate.

Electronic document receiver 40 includes any device capable of receiving an electronic document through wired or wireless communication, such as a facsimile machine, a multifunction printer, a desktop computer, a mobile phone, a personal digital assistant (PDA), a host server, a portable computer, and a digital sender. Accordingly, electronic document receiver 40 further includes electronic address 82 which includes any one of an electronic mail address 84, facsimile number 86, a host address 88, and a uniform resource locator address 90.

Controller 64 includes hardware, software, firmware or combination of these. In one preferred embodiment, controller 64 includes a computer server or other microprocessor based system capable of performing a sequence and logic operations. In addition, controller 64 can include a microprocessor embedded systems/appliance incorporating tailored appliance hardware and/or dedicated single purpose hardware.

Network communication link 68, as used herein, includes an internet communication link (e.g., the Internet), an intranet communication link, or similar high-speed communication link. In one preferred embodiment, network communication link 68 includes an Internet communication link 96. Network communication link 68 facilitates communication between mobile computing device 20, electronic document sender 30, and electronic document receiver 40.

Wireless communication between mobile computing device 20, electronic document sender 30, and electronic document receiver 40 is accomplished using wireless communication module 66 with one or more known communication and application protocols such as Wireless Application Protocol (WAP), Bluetooth, Infrared (IrDA, FiR), 802.11 as well as other communication and application protocols known to those skilled in the art. Of particular interest are wireless communication protocols such as infrared (e.g., FiR), Bluetooth, and 802.11 which permit direct radio or beamed communication between two or more compatible devices that operate independently of a network and independently of network communication link 68. This feature permits direct one-on-one communication between two similarly configured computing devices without any communication intermediary. In the example of the Bluetooth protocol, the communication link preferably is established by the mere presence of each respective device (e.g., mobile computing device 20 and electronic document sender 30) in close proximity to each other. This instant synchronization enables users to immediately communicate with each other without taking time to manually establish a connection or communication link. If necessary, mobile computing device 20, electronic document sender 30, and electronic document receiver 40 optionally communicate with each other through more conventional indirect routes such as wired or wireless network or internet links, or wired or wireless telecommunications networks. Finally, electronic document sender 30 optionally is directly connected to mobile computing device 20 and/or electronic document receiver 40 via direct communication links 94.

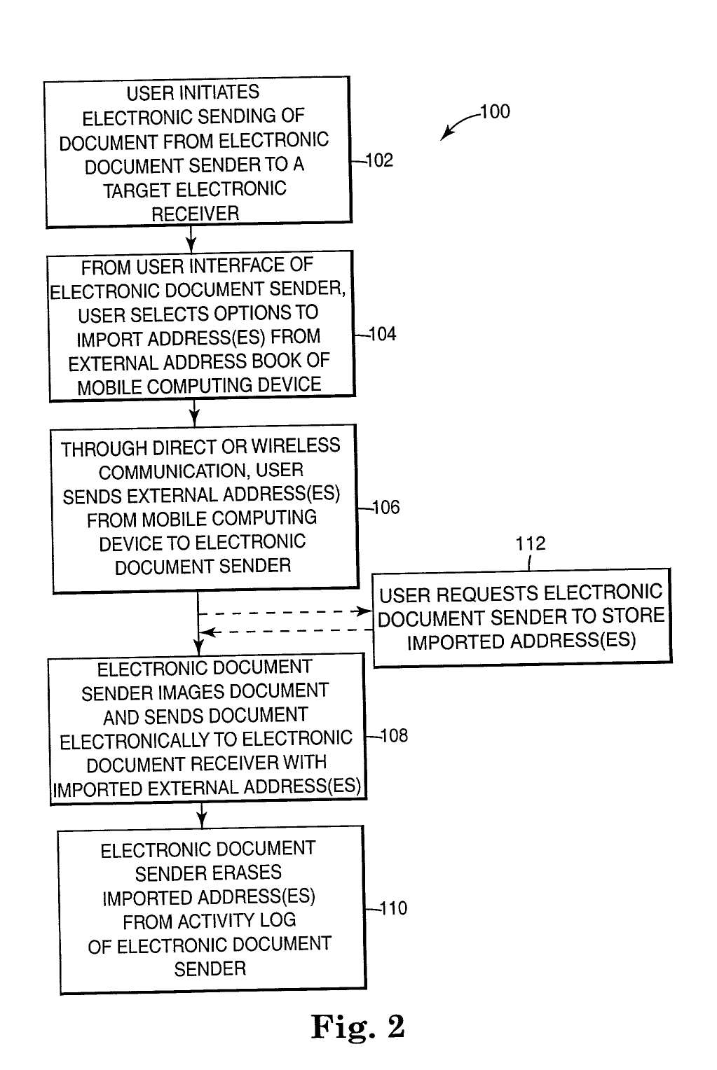

Electronic document sending system 10 is used in a method 100 of electronic document sending, according to one embodiment of the present invention. As shown in FIG. 2, in a first step (102) of method 100, a user initiates electronic sending of an electronic document from electronic document sender 30 to target electronic document receiver 40 at electronic address 82. For example, a user may desire to send a document as electronic mail to the electronic mail address of a desktop computer. Accordingly the user activates a send functioning in user interface 70 of electronic document sender 30. However, in some situations, the desired electronic address 82 will not be available in internal address book 75 of electronic document sender 30. The user must manually enter electronic address 82 into electronic document sender 30 or get electronic address 82 of electronic document receiver 40 from another source. Accordingly, in the next step(104) of method 100, user accesses user interface 70 of electronic document sender 30 to select an option to import electronic address(es) from external address book 62 of mobile computing device 20. Through direct or wireless communication (via wireless communication module 66), electronic address(es) from external address book 62 of mobile computing device 20 are imported into internal address book 75 of electronic document sender 30 (step 106). If not already performed, electronic document sender 30 images a paper document into an electronic document, and then sends the electronic document to electronic document receiver 40 using the imported electronic address 82, through wired or wireless communication (step 108).

Method 100 optionally includes another step 110, in which electronic document sender 30 erases imported electronic address(es) from internal address book 75 and/or from an activity log of electronic document sender 30. This step insures the privacy and confidentiality of the user's electronic address information so that no trace remains of which documents were sent and where the documents were sent. Method 100 also optionally includes an additional step (step 112) in which user requests that electronic document sender 30 stores imported electronic address 82 in internal address book 75 of electronic document sender 30.

Accordingly, method 100 permits a user to operate any electronic document sender 30 with the same convenience as if it were their own personal electronic document sender, by allowing the user to easily access their own external address book 62 of mobile computing device 20. This arrangement permits the user to simply walkup to the electronic document sender and immediately send the electronic document while avoiding the error prone, time consuming manual entry of one or more electronic addresses into the electronic document sender. Moreover, the user can be assured of the safety and confidentiality of the information in their external address book 62 since any electronic addresses imported into electronic document sender 30 optionally are erased after their use in transmitting an electronic document.

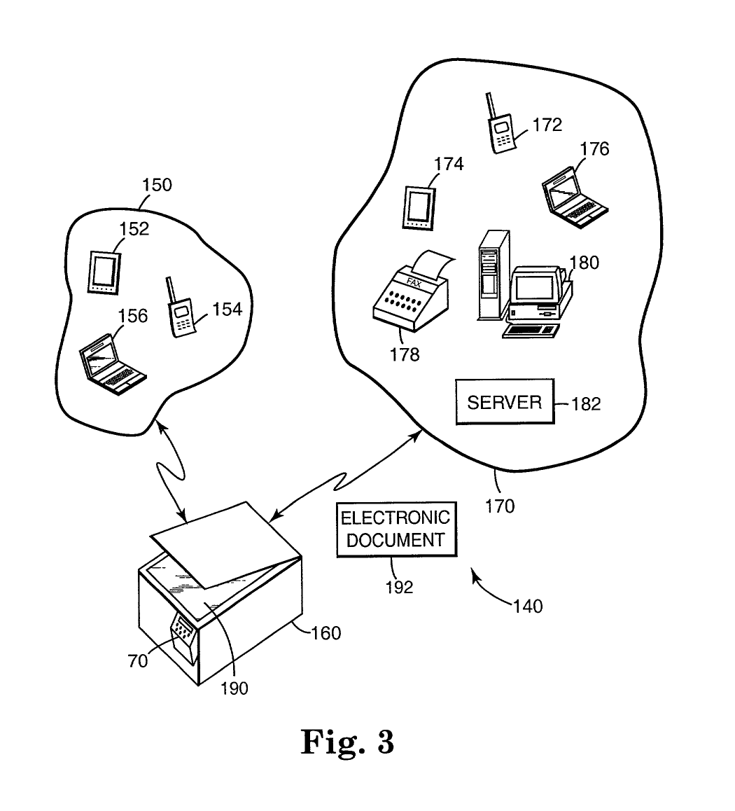

FIG. 3 shows an electronic document sending system 140 of the present invention which further illustrates electronic document sending system 10. As shown in FIG. 3, document sending system 140 includes mobile computing device(s) 150, such as personal digital assistant 152, mobile phone 154, portable computer 156, as well as electronic document sender 160 with user interface 70, and electronic document receiver 170. Electronic document receiver 170 includes any one of mobile phone 172, personal digital assistant 174, portable computer 176, fax machine 178, desktop computer 180, and server 182. Mobile computing device 150, electronic document sender 160, and electronic document receiver 170, each carry substantially the same features and attributes as mobile computing device 20, electronic document sender 30, and electronic document receiver 40, as was described and illustrated in association with FIG. 1.

Using method 100,the user employs one or more components of electronic document sending system 140 to send paper document 190 as electronic document 192 from electronic document sender 160 to electronic document receiver 170 at electronic address 82 obtained from mobile computing device 150.

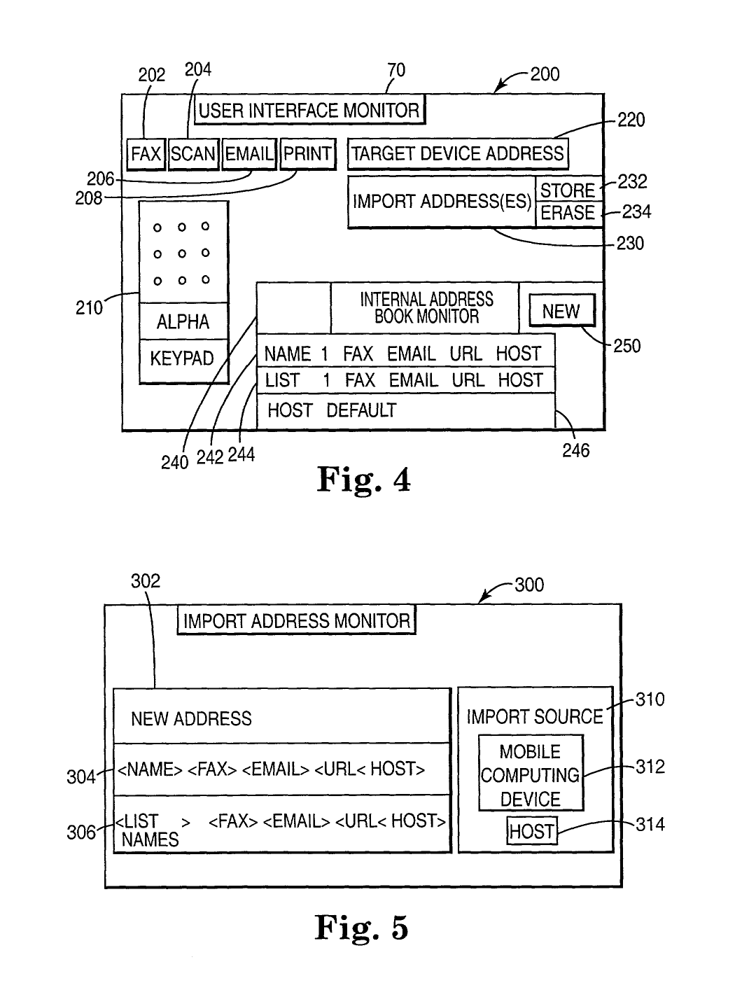

FIG. 4 illustrates monitor 200 operating on user interface 70 (FIG. 1) of electronic document sender 30 for performing method 100 with system 10. User interface monitor 200 operates electronic document sender 30 and facilitates communication between mobile computing device 20, electronic document sender 30, and electronic document receiver 40. In one embodiment, user interface monitor 200 includes fax function 202, scan function 204, email function 206, and print function 208. User interface monitor 200 further includes alphanumeric keypad input device 210, target device address function 220, import address function 230, and internal address book monitor 240. Import address function 230 includes store function 232 and erase function 234 while internal address book monitor 240 further includes individual address(es) 242 and/or distribution list address(es) 244, each including at least one of a fax number, email address, uniform resource locator (URL), and/or host address. Internal address book monitor 240 also includes host address 246, which acts as a default for electronic document sender 30 to scan to host when no other target address is specified. New function 250 permits identification and entry of new electronic addresses.

Upon activation of import address function 230, the user is taken to import address monitor 300 in user interface 70 as shown in FIG. 5. Import address monitor 300 comprises new address function 302 which includes individual address(es) function 304 and list address(es) function 306, each of which include fields for electronic addresses of the following types: fax, email, uniform resource locator (URL), and host. Import source function 310 allows the user to select the source from which addresses can be imported, such as mobile computing device source 312 and host source 314.

User interface 70, including associated user interface monitor 200 and import address monitor 300, can be implemented in hardware via a microprocessor, programmable logic device, or state machine, and firmware, or in software within a given device. In one aspect user interface 70 operates as a touchscreen permitting activation of its functions without use a conventional keypad. In another aspect, at least a portion of the software programming is written in Java programming language, and user interface 70 communicates with other computing devices via network communication link 68 using a communication bus protocol. For example, the present invention optionally can use a TCP/IP protocol suite for data transport. In another aspect, the present invention does not use a TCP/IP protocol suite for data transport. Other programming languages and communication bus protocols suitable for use with user interface 70 and system 10 will be apparent to those skilled in the art.

A system and method of the present invention for electronic document sending carries numerous advantageous features. Foremost, convenience and control are provided, by permitting an electronic document sender to obtain electronic addresses from an external address book of a mobile computing device. This feature allows a user to tap into their own well developed address book without the need to manually enter electronic addresses into in an electronic document sender, which is time-consuming. With large groups of addresses, such as distribution lists, the conventional manual entry process leads to many errors and wastes considerable time. In contrast, the feature of importing addresses from an external address book with method and system of the present invention is particularly effective for large distribution lists of electronic addresses. Accordingly, a method and system of the present invention permits walkup use of an electronic document sender by taking advantage of the wealth of electronic address information already contained in a mobile computing device personal to the user.

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of electronic document sending comprising:
sending an electronic document from an electronic document sender to an electronic document receiver having an electronic address; and
electronically obtaining the electronic address from an address book located externally of the electronic document sender.

2. The method of claim 1 wherein the obtaining step further comprises:
disposing the external address book in a mobile computing device.

3. The method of claim 1 and further comprising:
providing the electronic document sender as at least one of a multi-function printer, a scanner, and a digital sender.

4. The method of claim 1 and further comprising:
providing the mobile computing device as at least one of a personal digital assistant, a mobile phone, and a portable computer.

5. The method of claim 1 and further comprising:
providing the electronic document receiver as at least one of a facsimile machine, a multifunction printer, a desktop computer, a mobile phone, a personal digital assistant, a host server, a portable computer, and a digital sender.

6. The method of claim 1 and further comprising:
providing the electronic address as at least one of a facsimile number, an uniform resource locator, a host computer address, an network address, and an electronic mail address.

7. A method of document sending comprising:
importing an electronic address of an electronic document receiver from a mobile computing device into an electronic document sender; and
sending an electronic document from the electronic document sender to the electronic document receiver using the electronic address.

8. The method of claim 7 comprising:
performing the importing step through wireless communication between the electronic document sender and the mobile computing device.

9. The method of claim 7 and further comprising:
imaging a paper document with the electronic document sender to produce the electronic document.

10. The method of claim 7 and further comprising:
storing the imported electronic address in an internal address book of the electronic document sender.

11. The method of claim 7 and further comprising:
erasing the imported electronic address from at least one of an activity log and an internal address book of the electronic document sender.

12. An electronic document sender comprising:
an imaging mechanism configured for creating an electronic document from a paper document;
a user interface configured for activating the imaging mechanism, configured for requesting an electronic address of an electronic document receiver from a mobile computing device, and configured for initiating sending the electronic document to the electronic document receiver; and
a communication module configured for wirelessly obtaining the electronic address from the mobile computing device and configured for sending the electronic document to the electronic address of the electronic document receiver.

13. The electronic document sender of claim 12 wherein the electronic document sender comprises at least one of a multi-function printer, a scanner, a digital sender, and a facsimile machine, each of which incorporate the imaging mechanism, the user interface, and wireless communication module.

14. The electronic document sender of claim 12 wherein the user interface is configured to request from the mobile computing device a distribution list comprising a plurality of electronic addresses of electronic document receivers and the communication module is configured to obtain the distribution list of electronic addresses and send the electronic document to each electronic address in the distribution list.

15. An electronic document sending system comprising:
an electronic document receiver having an electronic address;
a mobile computing device having an external address book with the electronic address of the electronic document receiver; and
an electronic document sender configured for sending an electronic document to the electronic address of the electronic document receiver and configured for obtaining the electronic address from the address book of the mobile computing device.

16. A user interface of an electronic document sender comprising:
a initiation mechanism configured for initiating sending an electronic document to an electronic document receiver at an electronic address; and
a communication module configured for requesting the electronic address of the electronic document receiver from a mobile computing device.

17. The user interface of claim 16 and further comprising:
an internal address book for storing the electronic address of the electronic document receiver.

18. An address book of an electronic document sender comprising:
an internal storage and retrieval mechanism for maintaining a database of at least one electronic address of a electronic document receiver; and
an external retrieval mechanism configured for optionally obtaining the at least one electronic address of the electronic document receiver from a mobile computing device.

19. A mobile computing device comprising:
at least one of a portable computer, personal digital assistant, and a mobile phone, each of which includes:
an address book containing at least one electronic address of an electronic document receiver; and
a wireless communication module for transmitting the at least one electronic address from the mobile computing device to an electronic document sender.

20. An electronic document sender comprising:
an imaging mechanism configured for creating an electronic document from a paper document;
a user interface configured to perform the following tasks:
activating the imaging mechanism;
requesting an electronic address of an electronic document receiver from a mobile computing device; and
initiating sending the electronic document to the electronic document receiver; and
a communication module configured to perform the following tasks:
wirelessly obtaining the electronic address from the mobile computing device; and
sending the electronic document to the electronic address of the electronic document receiver.

21. A computer-readable medium having computer-executable instructions for performing a method of electronic document sending, the method comprising:
sending an electronic document from an electronic document sender to an electronic document receiver having an electronic address; and
electronically obtaining the electronic address from an address book located externally of the electronic document sender.

22. The method of claim 21 wherein the obtaining step further comprises:
disposing the external address book in a mobile computing device.

23. A computer-readable medium having computer-executable instructions for performing a method of document sending, the method comprising:
importing an electronic address of an electronic document receiver from a mobile computing device into an electronic document sender; and
sending an electronic document from the electronic document sender to the electronic document receiver using the electronic address.

24. The method of claim 23 comprising:
performing the importing step through wireless communication between the electronic document sender and the mobile computing device.

25. The method of claim 23 and further comprising:
imaging a paper document with the electronic document sender to produce the electronic document.
